(19) United States
(12) Patent Application Publication
(10) Pub. No.: US 2011/0117256 A1
(43) Pub. Date: May 19, 2011

(54) METHOD OF PROCESSING CHOCOLATE PRIOR TO INK JET PRINTING

(76) Inventors: Christian Ingvar Palmgren, Stockholm (SE); Robert Norman, Bro (SE)

(21) Appl. No.: 12/934,269

(22) PCT Filed: Mar. 12, 2009
(86) PCT No.: PCT/IB09/00495

§ 371 Date: Nov. 15, 2010

(30) Foreign Application Priority Data
Apr. 14, 2008 (GB) 0806621.9

(51) Int. Cl. A23G 1/50; A23P 1/10

(52) U.S. Cl. 426/383

(57) ABSTRACT

A method of processing the surface of the chocolate, such that an image may be printed thereon. The method includes the steps of creating an image, placing the chocolate (5, FIG. 3) in a printing apparatus (2), heating the surface of the chocolate, printing the created image on to the heated surface using water-based edible ink and cooling down (9) the chocolate to harden it. The apparatus for heating (4) the surface of the chocolate may form part of the printing apparatus. During heating the surface may be melted to a depth of between 0.1 to 1 mm. The printing apparatus may be an ink jet printer and the chocolate may be supported on a heat resistant tray during the heating and printing.

### FIELD OF THE INVENTION

The invention relates generally to the method of ink jet printing on genuine chocolate and more specifically to an exothermic method of process the genuine chocolate surface to make it hydrophilic to increase penetrability and to make it printable with water-based food grade ink without mechanically destroying its smooth surface.

### BACKGROUND OF THE INVENTION

There are different methods used to place artwork on to chocolate that are widely known by the people skilled in this niche. You can hand paint the chocolate surface directly or you can use different kind of transfer sheets to be printed and then placed on the chocolates in moulds.

To print direct on the surface of genuine chocolate is a more difficult task and there are no methods known or techniques available for chocolates having art printed thereon by using an ink jet printer with water-based food grade ink. The known methods available for having arts printed on chocolate is by first coating the chocolate surface with a thin layer of sugar paste or similar substances to form an intermediate printing layer. The genuine chocolate surface is oily and does not allow print with standard water-based food graded ink. Any attempt to print on a non-processed piece of chocolate with water-based ink only results in a non good-looking image that stays on the top of the oily chocolate surface like small drops of ink, unable to bond with the chocolate and easy to smear. To use any mechanical action such as grinding or brushing to make the surface more grainy/rough-textured to try to allow the ink to easier adhere to it will not improve the hydrophilic characteristics and it will not increase penetrability as the present invention does, any mechanical treatment of the chocolate surface as described above will also destroy its smoothness and its shiny appeal. To mechanically destroy the smooth surface will also result in an image with lower resolution than the optimal resolution for the flat and shiny moulded chocolate surface, due to the fact that an image can never have a higher resolution than the texture of the media it is printed on.

There are other techniques that using rice paper and then glue the paper on to the chocolate surface. All these methods have great limitations related to the time it takes to create the artwork, the price, and or the quality of the finished product. While these methods described above or other methods not described may be suitable for the particular purpose to which they address, they would not be suitable for the purpose of the present invention as heretofore described.

### SUMMARY OF THE INVENTION

The present invention relates generally to the method of ink jet printing on genuine chocolate and more specifically to an exothermic method of process the genuine chocolate surface to make it hydrophilic to increase penetrability and to make it printable with water-based food grade ink.

A primary object of the present invention is to provide a method of processing chocolates having art printed thereon that will overcome all the shortcomings in prior art devices and methods.

Another object of the present invention is to provide a method of processing chocolates having art printed thereon where standard chocolate can be used. Where the image is able to bond to the surface of standard chocolate, securing the image to be none smearing without affects the consistency of the finished product.

A further object of the present invention is to provide a method of processing chocolates having art printed thereon where an ink jet printer loaded with water-based food graded ink can be used.

A Yet further object of the present invention is to provide a method of processing chocolates having art printed thereon where to cost of the finished product is the lowest possible due to the fact that only food graded ink is used in addition to the chocolate.

A Still further object of the present invention is to provide a method of processing chocolates having art printed thereon where a heat resistant tray provides support for the chocolate pieces during the printing process.

A further object of the present invention is to provide a method of processing chocolates having art printed thereon where an exothermic process is used to make the oily chocolate hydrophilic and to increase penetrability, without mechanically destroying its smooth surface.

A further object of the present invention is to provide a method of processing chocolates having art printed thereon where cool air is used after print to harden the chocolate surface.

Additional objects of the present invention will appear as description proceeds.

A method of processing chocolates having art printed thereon is disclosed by the present invention. The method includes steps of creating the image using any graphic software. Placing the chocolate on a printing tray that supports the chocolate during the exothermic and printing process. Processing only the uppermost part of the chocolate surface to melt down a thin layer. Print an image by using water-based food grade ink in an ink jet printer that can adjust to the media height. Cool down the surface of the chocolate and force the ink to be absorbed by the chocolate. The image is now a bonded part of the chocolate surface and will present itself in high resolution and none smearing.

### BRIEF DESCRIPTION OF THE DRAWINGS

Various other objects, features and attendant advantages of the present invention will become more fully appreciated as the same becomes better understood when considered in conjunction with the accompanying drawings, in which like reference characters designate the same or similar parts throughout the several views.

FIG. 1 is a flow chart illustrating the method of the present invention for processing the chocolate surface and having an image printed thereon. Showing all step from creating the image to cooling the printed chocolate. Steps are marked in alphabetic order.

(A) Design the image to be printed by using a standard computer and software for graphic design. Designs the images in a way that the tray if correctly attached to its precision holders places the chocolate in accordance with the designed image and exposes the chocolate surface for the print.
(B) Place the chocolate items on the heat resistant tray, and place the tray on the printer table, using the precision holders to place it in an exact position. Adjust the print height to fit the media.
(C) Start the heater and set the power to correlate with the melting point of the chocolate loaded on the tray and the speed of print that are planned to use.
(D) Use the computer and the ink jet printer and print out the design on the chocolate. The printing process will move the table with the chocolate under the heater and give it the exact temperature to make it hydrophilic and to increase penetrability.
(E) The printing process will then move the table with the chocolate under the printer head and the image is printed with water-based ink to its processed surface.
(F) The printing process will then move the table with the chocolate in to the cooling tunnel, to cool down the chocolate so the surface harden.

FIG. 2 is a front-back view illustrating the method of the present invention for processing the chocolate surface and having an image printed thereon. Showing the steel tray (6), its precision holders (8), the heater (4), the ink jet printer (2), the printer table (1) the chocolate non printed (5), the chocolate printed (7) and the lateral movement of the printed item.

FIG. 3 is a side perspective view illustrating the method of the present invention for processing the chocolate surface and having an image printed thereon. Showing the heating direction and the lateral placement of the heater related to the printer head and the printed item, and also the lateral movement of the printed item. It also shows the steel tray (6), the heater (4), the ink jet printer (2), The printer head (3), the printer table (1) the chocolate non printed (5), the cooling tunnel (9), and the computer (10).

### DESCRIPTION OF THE REFERENCED NUMERALS

Turning now descriptively to the drawings, in which similar reference characters denote similar elements throughout the several views, the figures illustrate the method of processing chocolate having art printed thereon using the present invention. With regard to the reference numerals used, the following numbering is used throughout the varies drawing figures.

1. Flat-bed Ink jet Printer table

2. Flat-bed Ink jet printer

3. Ink disposal unit (Printer head)

4. Heating module

5. Chocolate non printed

6. Heat resistant tray

7. Printed chocolate

8. Tray precision holder

9. Cooling module.

10. Computer module.

### DETAILED DESCRIPTION OF THE PREFERRED EMBODIMENT

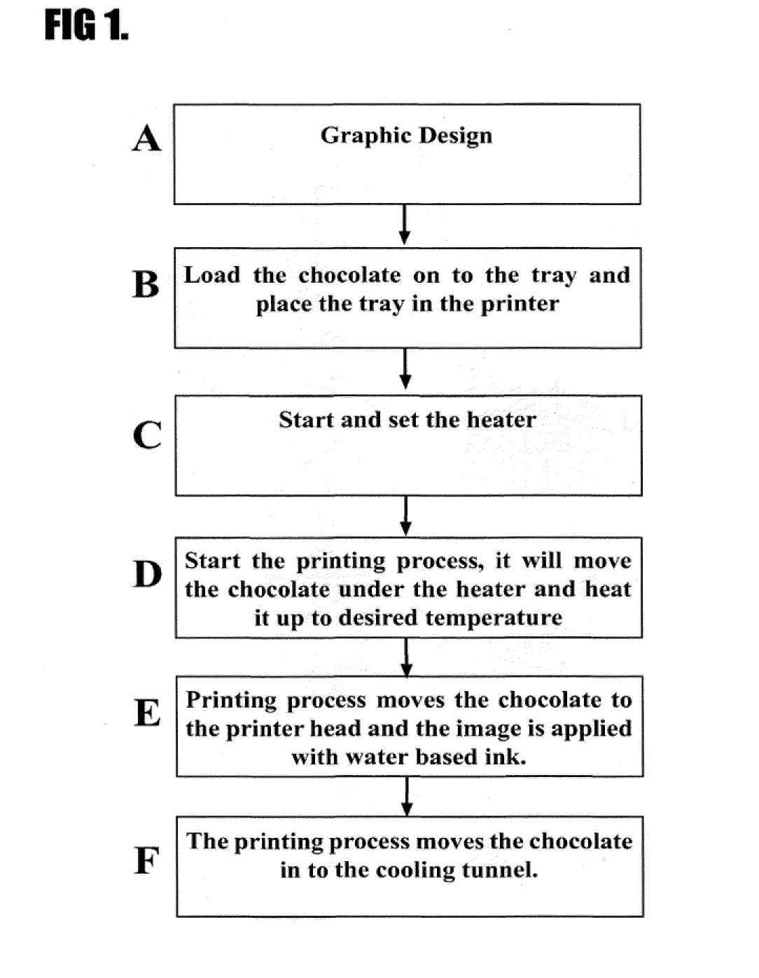

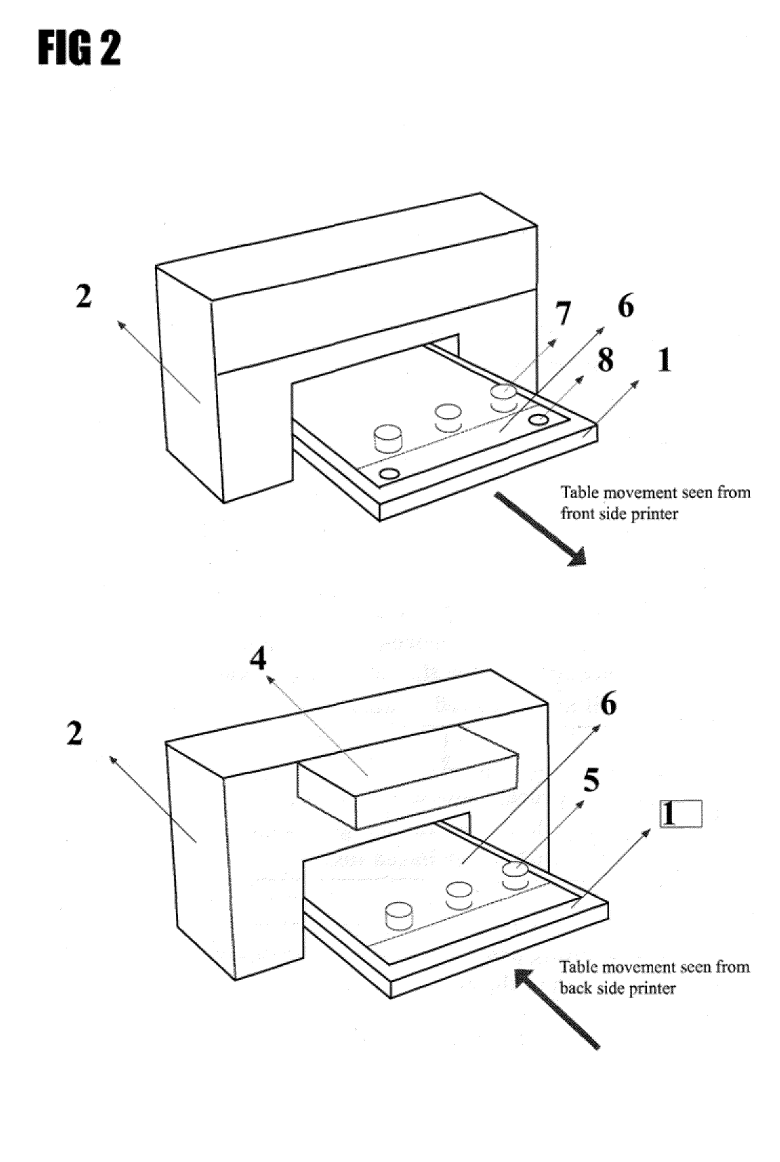

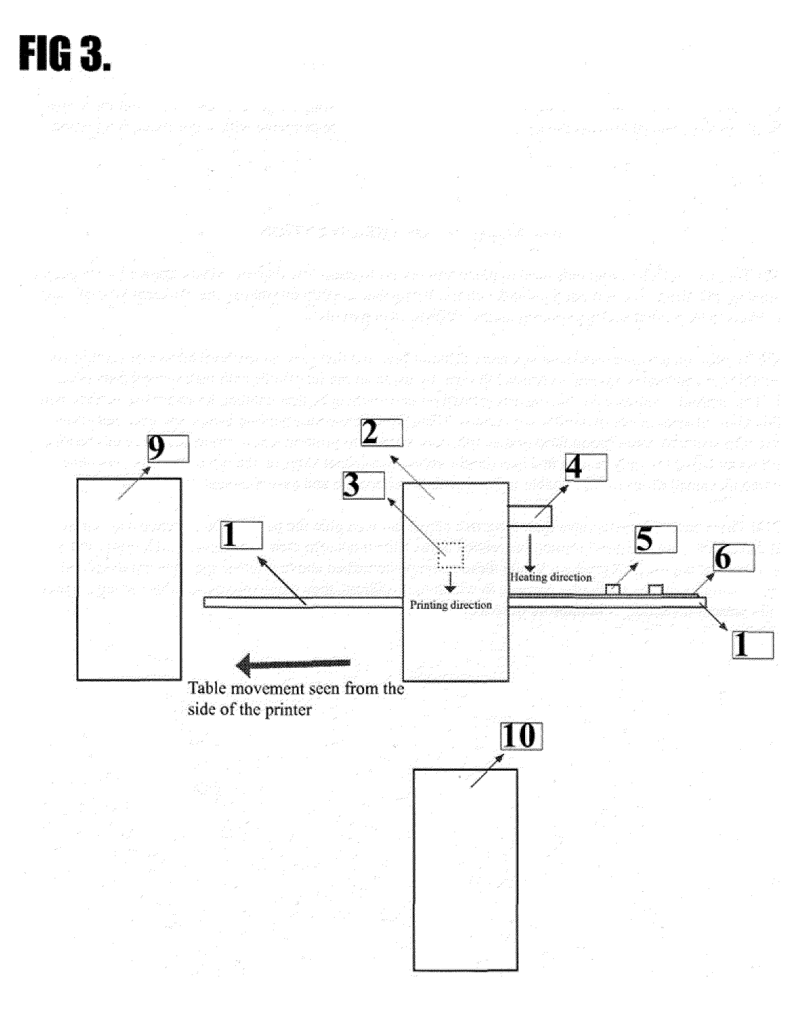

Turning now descriptively to the drawings, in wish similar reference characters denote similar elements throughout the several views. FIGS. 1 trough 3 illustrates the method of processing chocolate to have art printed thereon using this present invention.

The method of processing chocolates having art printed thereon is started by creating the image that shall be printed indicated in FIG. 1 (A). The standard computer FIG. 3 (10) is used for this purpose. It can be loaded with any standard software capable of editing and printing graphic files.

The second step FIG. 1 (B) in the method of processing chocolates having art printed thereon is to place the non printed chocolates FIG. 2 (5) on the surface of the heat resistant tray FIG. 2 (6) built preferably in stainless steel. The tray is formed to support the lateral movement of the chocolate pieces during the complete process, and has precision holders FIG. 2 (8) to guarantee its position. The tray is then placed in the ink jet printer FIG. 2 (2) preferable a flat bed printer that has a printer table FIG. 2 (1).

The third step FIG. 1 (C) in the method of processing chocolates having art printed thereon is to set the heater FIG. 2 (4) to deliver the amount of energy required for the exothermic process not melting more than the desired layer of the chocolate FIG. 2 (5), and then use the exothermic process to melt the chocolate in combination of moving the table FIG. 2 (1) in a print mode or by applying heat manually. To set the heater FIG. 2 (4) to produce a heat that correlates with the melting temperature of the chocolate loaded FIG. 2 (5) and the time the chocolate will be exposed for the heat. Basically chocolate melting temperature is between 28-39 degree Celsius. The heater FIG. 2 (4) shall preferable be of type radiative heaters but even convector types will do. The heater shall preferable operates in the wave length of 3000 nm, as this is the best absorption spectrum for water, but other wave-lengths is acceptable as the heater can be adjusted both in effect and the height between the heating element and the chocolate surface. The less deep the heating process penetrates the chocolate the better the finished result will be, preferable 0.1-1 mm of the top layer of the surface shall be affected. The heater FIG. 2 (4) can be mounted on the printer part FIG. 2 (2), mounted in a separate rack or hand hold during the heating process. It all depends on the volume of products printed and the budget available for the investment. The most important thing is that the energy output on the surface of the chocolate, correlates with the printing speed of the product and its melting point The heater requires a power density of 40 W/cm and a response time of maximum 2 sec to be ideal for this method. The moisture released from the chocolate surface by the heat is making the chocolate hydrophilic and increase the penetrability of the water-based ink in to the soft chocolate layer.

The forth step FIG. 1 (D) in the method of processing chocolates having art printed thereon is to process the chocolate surface with heat so that the chocolate FIG. 2 (5) will be printable with water-based food grade ink. The heating process is the first phase of the printing session that is initiated by using the computer FIG. 3 (10) and demand a print out with the selected ink jet printer FIG. 3 (2). The printer table FIG. 3 (1) will move the tray FIG. 3 (6) that holds the chocolate FIG. 3 (5) in place towards the heater FIG. 3 (4) and the surface will be heated accordingly prior to print. The selection of printer speed can be done in the software driver installed in the computer FIG. 3 (10) for the ink jet printer FIG. 3 (2). The shorter the time between the heating process and the printing process the better the finished result will be and the easier the system will be to operate.

The fifth step FIG. 1 (E) in the method of processing chocolates having art printed thereon is to print on the chocolate surface FIG. 3 (5) by using a standard ink jet printer FIG. 3 (2) loaded with water-based food graded ink. The printer FIG. 3 (2) has to be adjustable to the media height and preferable a flatbed printer shall be used. To dispose the ink a standard printer head FIG. 3 (3) of any type can be used as this method only need water-based ink. The computer FIG. 3 (10) provide the printer FIG. 3 (2) with the streaming information needed for the printer to replicate the image produced in the graphic software that runs on the computer. FIG. 3(10) The printing tray FIG. 3 (6) is providing support for the chocolate FIG. 2 (5) during the process.

The sixth step FIG. 1 (F) in the method of processing chocolates having art printed thereon is to cool down the printed chocolate surface FIG. 2 (7) to its ideal hardening temperature, normally between 13-18 Degrees Celsius. A cooling tunnel FIG. 3 (9) is preferable but even a fridge with the humidity of around 50% can be used for this purpose. When the crystals in the melted top layer of the chocolate form a hard surface the moisture released from the chocolate surface during the heating process will now bond with the chocolate again, forcing the image printed with water based ink to become a part thereof and by that giving the finished product the look of an image being a natural part of the top chocolate layer. The image produced by using this method is not easy to smear without melting the surface of the chocolate, and it is very economical and suitable for higher volumes to manufacture as the only additives in this method is water-based edible ink in addition to the chocolate.

The embodiment of the invention which have been described are merely illustrative, it is not intended to be limited to the details above, since it will be understood that various omissions, modifications, substitutions and changes in the details of the method illustrated an its operation can be made by those skilled in the art without departing in any way from the spirit of the present invention.

What is claimed is:

1. A method for printing an image on to a chocolate surface comprising first heating the surface to melt a surface layer of the chocolate and then printing the image on to the melted surface using water-based edible ink.

2. A method for printing an image on to a chocolate surface as claimed in claim 1 wherein an ink jet printer is used to apply the ink to the chocolate surface.

3. A method for printing an image on to a chocolate surface as claimed in claim 2 wherein the height of the ink jet printer is adjustable to accommodate different chocolate sizes.

4. A method for printing an image on to a chocolate surface as claimed in any preceding claim wherein the chocolate is supported on a heat resistant tray.
